(19) United States
(12) Patent Application Publication
(10) Pub. No.: US 2026/0001743 A1
(43) Pub. Date: Jan. 1, 2026

(54) ELEVATOR SYSTEM WITH APPROACHING HAZARD WARNING SYSTEM

(71) Applicant: OTIS ELEVATOR COMPANY, Farmington, CT (US)

(72) Inventors: Randall Roberts, Hebron, CT (US); Johanna Whitwell, Chicago, IL (US); Kathleen Nicole Moore, West Hartford, CT (US); James Tilsley Auxier, Palm Beach Gardens, FL (US); Kyler Vensel, Wolcott, CT (US); Bruce W. Horne, Cromwell, CT (US); Yingxin Gao, Farmington, CT (US)

(21) Appl. No.: 18/758,210

(22) Filed: Jun. 28, 2024

(51) Int. Cl. B66B 5/00; B66B 7/06

(52) U.S. Cl. CPC B66B 5/0087; B66B 7/066

(57) ABSTRACT

An elevator system having: a hoistway; an elevator car movable within the hoistway; a controller operationally coupled to the elevator car; a counterweight coupled to the elevator car and movable within the hoistway; and an approaching-hazard-warning-system that has: a warning system controller; a range finding sensor, operationally coupled to the warning system controller, and mounted to one of the elevator car, the counterweight and the hoistway wall, wherein, while operating in an inspection mode, the warning system controller is configured to receive sensor data from the range finding sensor, detect when a distance between the elevator car and the counterweight is less than a stop distance while the elevator car and the counterweight are moving toward each other, and execute a first responsive action including one or more of slowing the elevator car by communicating with the car controller, stopping the elevator car and sounding a first audible alert.

### BACKGROUND

The embodiments described herein relate to an elevator system and more specifically to an elevator system with an approaching hazard warning system.

Elevator systems may utilize an approaching hazard warning system (AHWS) that functions when a top of an elevator car is less than a predetermined distance, for example, 2400 mm (96 in.) from a counterweight assembly while the elevator car is operating in an inspection mode. Within that distance, power is removed from a driving-machine motor of the elevator car and a brake may be applied along with a visual and audible signal for notifying a mechanic on or within the elevator car. This helps ensure the mechanic does not accidentally contact the counterweight.

### BRIEF SUMMARY

An elevator system including: a hoistway having a hoistway wall; an elevator car that is movable within the hoistway; a controller operationally coupled to the elevator car; a counterweight coupled to the elevator car and movable within the hoistway; and an approaching hazard warning system that includes: a warning system controller; a range finding sensor, operationally coupled to the warning system controller, and mounted to one of the elevator car, the counterweight and the hoistway wall, wherein, while operating in an inspection mode, the warning system controller is configured to receive sensor data from the range finding sensor, detect when a distance between the elevator car and the counterweight is less than a stop distance while the elevator car and the counterweight are moving toward each other, and execute a first responsive action including one or more of slowing the elevator car by communicating with the car controller, stopping the elevator car and sounding a first audible alert.

In addition to one or more aspects of the system or as an alternate, while operating in the inspection mode, the warning system controller is configured to detect when the distance between the elevator car and the counterweight becomes less than a warning distance and greater than the stop distance while the elevator car and the counterweight are moving toward each other, and execute a second responsive action including one or more of (i) communicating with the car controller for slowing the elevator car; (ii) stopping the car; and (iii) sounding a second audible alert which is different from the first audible alert.

In addition to one or more aspects of the system or as an alternate, while operating in the inspection mode, the warning system controller is configured to detect when the distance between the elevator car and the counterweight is greater than the warning distance while the elevator car is moving and sound a third audible alert that differs from the first and second audible alerts.

In addition to one or more aspects of the system or as an alternate, the system includes an elevator machine configured to raise and lower the elevator car in the hoistway and a relay operationally coupled to the elevator machine and controlled by the warning system controller, wherein the warning system controller is configured to open the relay upon detecting the distance between the elevator car and the counterweight is less than the stop distance, to thereby stop the elevator car.

In addition to one or more aspects of the system or as an alternate: the sensor is mounted to the counterweight and configured to transmit to the controller as the sensor data a sensed distance to the elevator car; or the sensor is mounted to the hoistway wall and configured to transmit to the controller as the sensor data a sensed distance between the elevator car and the counterweight; or the sensor is mounted to the elevator car and configured to transmit to the warning system controller as the sensor data a sensed distance to the counterweight.

In addition to one or more aspects of the system or as an alternate, the system includes a detectable object located on the hoistway wall, wherein the sensor is configured to sense the detectable object and thereby sense the distance to the counterweight.

In addition to one or more aspects of the system or as an alternate, the sensor is LiDAR or mmWave; or the sensor has 1D, 2D or 3D field of view.

In addition to one or more aspects of the system or as an alternate, the system includes a detectable object on the hoistway wall, wherein the sensor is configured to sense the detectable object and thereby sense the distance to the elevator car.

In addition to one or more aspects of the system or as an alternate, the system includes a plurality of detectable objects mounted on the hoistway, wherein the sensor is configured to sense each of the objects and, responsive to the sensing, the system is configured to execute one or more of a plurality of responsive measures.

In addition to one or more aspects of the system or as an alternate, the warning system controller is configured to adjust one or more of the stop distance and the warning distance based on predetermined factors.

A method of operating an approaching hazard warning system, of an elevator system, while the elevator system is in an inspection mode, the method including: receiving, by a warning system controller, sensor data from a range finding sensor that is operationally coupled to the warning system controller and mounted to one of an elevator car of the elevator system, a counterweight of the elevator system, and a hoistway wall of a hoistway of the elevator system in which the elevator car and the counterweight are configured to move toward and away from each other; detecting, by the warning system controller, when a distance between the elevator car and the counterweight is less than a stop distance while the elevator car and the counterweight are moving toward each other; and executing, by the warning system controller, a first responsive action including one or more of slowing the elevator car by communicating with the car controller, stopping the elevator car and sounding a first audible alert.

In addition to one or more aspects of the method or as an alternate, the method includes the warning system controller: detecting when the distance between the elevator car and the counterweight becomes less than a warning distance and greater than the stop distance while the elevator car and the counterweight are moving toward each other; and executing a second responsive action including one or more of (i) communicating with a car controller for slowing the elevator car; (ii) stopping the car; and (iii) sounding a second audible alert which is different from the first audible alert.

In addition to one or more aspects of the method or as an alternate, the method includes the warning system controller: detecting when the distance between the elevator car and the counterweight is greater than the warning distance while the elevator car is moving; and sounding a third audible alert that differs from the first and second audible alerts.

In addition to one or more aspects of the method or as an alternate, the method includes the warning system controller: opening a relay operationally coupled to an elevator machine of the elevator system and controlled by the warning system controller, upon detecting that the distance between the elevator car and the counterweight is less than the stop distance, to thereby stop the elevator car.

In addition to one or more aspects of the method or as an alternate, the method includes: the sensor, mounted to the elevator car, transmitting to the warning system controller as the sensor data a sensed distance to the counterweight; or the sensor sensing the detectable object on the hoistway wall and thereby sensing the distance to the counterweight; or the sensor, mounted to the counterweight, transmitting to the warning system controller as the sensor data a sensed distance to the elevator car.

In addition to one or more aspects of the method or as an alternate, the sensor is LiDAR or mmWave; or the sensor has 1D, 2D or 3D field of view.

In addition to one or more aspects of the method or as an alternate, the method includes the sensor sensing the detectable object on the hoistway wall and thereby sensing the distance to the elevator car.

In addition to one or more aspects of the method or as an alternate, the method includes the sensor, mounted to the hoistway wall, transmitting to the warning system controller as the sensor data a sensed distance between the elevator car and the counterweight.

In addition to one or more aspects of the method or as an alternate, the method includes the warning system controller adjusting one or more of the stop distance and the warning distance based on predetermined factors.

In addition to one or more aspects of the method or as an alternate, the first responsive action includes opening a safety chain and performing an emergency-stop; and the method includes executing a recovery option upon actuation of a user controlled switch, whereby the elevator car is thereafter configured to resume running in inspection mode.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2A shows aspects of the elevator system with an approaching hazard warning system having a sensor on the elevator car configured to sense a an approaching counterweight;

FIG. 2B shows aspects of the elevator system with an approaching hazard warning system having a sensor on the elevator car configured to sense an approaching counterweight via a detectable object on a hoistway wall, where the counterweight is outside of a warning distance;

FIG. 2C shows aspects of the elevator system with an approaching hazard warning system having a sensor on the elevator car configured to sense an approaching counterweight via a detectable object on a hoistway wall, where the counterweight is inside of a stop distance;

FIG. 3 is a flowchart showing an operation of an approaching hazard warning system while the elevator system is in an inspection mode;

FIG. 4 shows additional aspects of the operation shown in FIG. 3, where sensors are mounted to the elevator car;

FIG. 5 shows additional aspects of the operation shown in FIG. 3, where sensors are mounted to the counterweight;

FIG. 6 shows additional aspects of the operation shown in FIG. 3 where sensors are mounted to a hoistway wall; and

FIG. 7 shows aspects of executing a recovery option upon actuation of a user controlled switch after the system executes a responsive action of stopping the elevator car.

### DETAILED DESCRIPTION

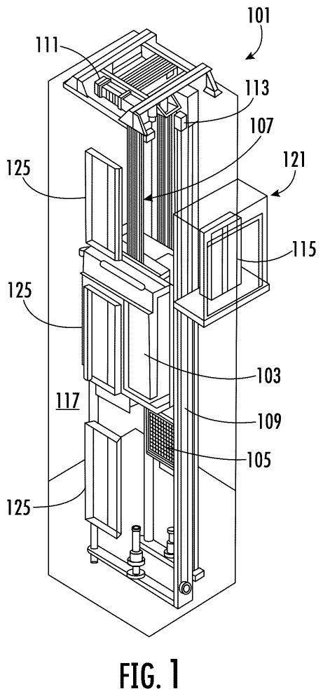

FIG. 1 is a perspective view of an elevator system 101 including an elevator car 103, a counterweight 105, a tension member 107, a guide rail (or rail system) 109, a machine (or machine system) 111, a position reference system 113, and an electronic elevator controller (system controller) 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft (or hoistway) 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The elevator system controller 115 may be located, as shown, in a controller room 121 of the elevator shaft 117 and is configured to control the operation of the elevator system 101, and particularly the elevator car 103. It is to be appreciated that the elevator system controller 115 need not be in the controller room 121 but may be in the hoistway or other location in the elevator system. For example, the elevator system controller 115 may provide drive signals to the machine 111 to control the acceleration, deceleration, leveling, stopping, etc. of the elevator car 103. The elevator system controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the elevator system controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117. FIG. 1 is merely a non-limiting example presented for illustrative and explanatory purposes.

The disclosed embodiments provide an elevator system 101 in which the elevator system controller 115 is capable of operating in two modes, including a normal mode and an inspection mode. In the inspection mode, a mechanic 220 may be located on the elevator car 103 and the system 101 is configured to detect the presence of the mechanic 220 and take measures to ensure the safety of the mechanic 220.

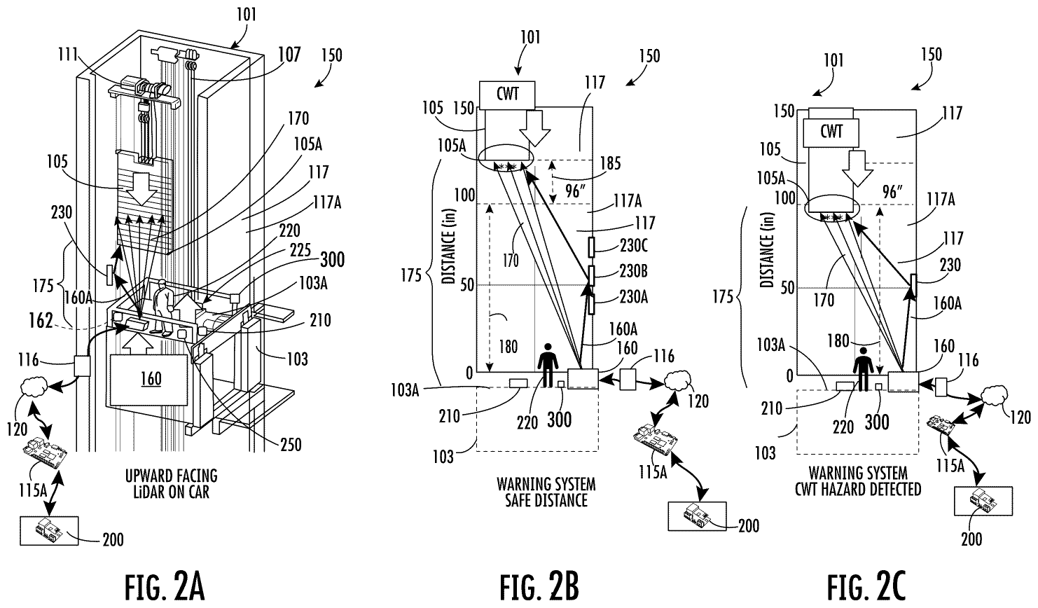

FIG. 2A shows aspects of the elevator system with an approaching hazard warning system having a sensor on the elevator car configured to sense a location of an approaching counterweight. The sensor in one embodiment is shown and referenced for simplicity as being on top of the elevator car. However, that is not intended on limiting the scope of the embodiments. That is, the sensor may be on the top, the bottom, or other portion of the elevator car to detect relative motion and proximity between the elevator car and counterweight. As indicated herein, the distance between the car and the counterweight could be inferred from viewing the counterweight or the detectable 230 in the hoistway.

Specifically, the system 101 has an approaching hazard warning system (AHWS) 150 that includes a range finding sensor 160 that has a warning system controller 115A may be operationally coupled to the car (or system) controller 115 (FIG. 1). In one embodiment, the car controller 115 and warning system controller 115A are configured as a unitary component. Reference to the elevator system controller 115 herein, by its context, will be to either the car controller 115 or the warning system controller 115A.

In one embodiment, there is one sensor 160 related to the AHW system, which is described herein as a range sensor. The object 230 could also be detected by a sensor 160 that picks up a change in the reflected return signal, even though the distance between object 230 and the car 103 (or the counterweight 105 if the sensor 160 is on it) could be the same. That is, in one embodiment, the sensor 160 has a binary determination, i.e. it sees the object 230 or it does not.

The range finding sensor 160 may be a LiDAR sensor, a millimeter wave sensor, radar sensor, depth sensor, an RGB-D camera, as non-limiting examples, having a view field 170. In one embodiment, the RGB-D camera (which provides an image in pixels and also assigns range data to each pixel) may be utilized to detect the object 230, and the sensor 160 could, e.g., be utilized to detect a relatively simple image reflectance measurement, where the relative distance is the same, and the sensor can pick up the object 230 if it has, e.g., reflective properties.

A field of view for the sensor 160 could be 1-D (a line), 2-D (a conical area section) or 3-D (a conical shape). The sensor 160 may be mounted to the elevator car 103, and the sensor 160 is a range sensor to detect when the counterweight 105 is within the view field 170. For simplicity, in one embodiment the range sensor is shown and referred herein as being upward facing to detect the bottom 105A of the counterweight 105. However, that is not intended on limiting the scope of the embodiments. That is, the range sensor may face in any required direction to detect the bottom, top or other portion of the counterweight 105 to detect relative motion and proximity between the elevator car and counterweight.

The sensor 160 may be mounted to the bottom 105A of the counterweight 105, and the sensor is a range sensor to detect when the elevator car 103 is within the view field 170. The sensor in one embodiment is shown and referenced for simplicity as being on bottom of the counterweight. However, that is not intended on limiting the scope of the embodiments. That is, the sensor may be on the bottom, the top, or other portion of the counterweight to detect relative motion and proximity between the elevator car and counterweight. In addition, for simplicity, in one embodiment the range sensor is shown and referred herein as being downward facing. However, that is not intended on limiting the scope of the embodiments. That is, the range sensor may face in any required direction to detect the bottom, top or other portion of the elevator car to detect relative motion and proximity between the elevator car and counterweight.

The sensor 160 may be mounted in the hoistway 117, in which case the sensor may be a wide-angle sensor to sense either the elevator car 103 or the counterweight 105 or both depending on the view field 170. The identified sensor mounting locations and sensor configurations are non-limiting as the sensor can sense one or both of the counterweight and the car. For simplicity, the figures show the sensor 160 mounted to the elevator car 103, as indicated, though this is not limiting. The sensor 160 communicates sensor data 116 representing the sensed distance 175 to the warning system controller 115A, e.g., over a network 120.

FIG. 2B shows aspects of the elevator system with an approaching hazard warning system having a sensor on the elevator car configured to sense an approaching counterweight when still at an identified safe distance. FIG. 2C shows that same system when the car is not at a safe distance away from the counterweight. The approaching hazard warning system may be connected to the safety chain of the elevator, wherein it would open the chain, which cuts power to the brake and elevator drive, resulting in an emergency stop. The system could be connected to the controller, in which case it could initiate a controlled response, such as slowing down and/or stopping the elevator car with a motor controlled deceleration profile. These are non-limiting examples of integration and operation of the approaching hazard warning system.

In the inspection mode, when the warning system controller 115A determines the counterweight 105 and elevator car 103, while moving towards each other, have moved within a predetermined stop distance (or first distance) 180 of each other, such as eight feet (2.4 meters; 96 inches), the warning system controller 115A is configured to execute a first responsive action. The first responsive action is opening a relay 200 that is controlled by the warning system controller 115A. The relay 200 provides is an independent line to the power delivered to the elevator machine, such that when the relay is opened, power is removed from the elevator machine, thus resulting loss of propulsive motor torque and the brake drops. The first responsive action may also include providing proximity alert (first audible alert) via a speaker 210 on the elevator car 103 to warn a mechanic 220. In one embodiment, the first response is the warning system controller communicating with the car controller to slow the speed of the car and issue an alert. The relatively short predetermined stop distance (8 feet/2.4 m) 180 and small required field of view is achievable with a low cost one dimension or two dimension LiDAR sensor.

In one embodiment, the car controller 115 runs the elevator car 103 at a first max speed in the normal mode. When in an inspection mode the car controller 115 runs the elevator car 103 at a second max speed, slower than the first max speed, for as long as the elevator car 103 and counterweight 106 are spaced apart by distance that is greater than, for example, a second distance (a warning distance) 185 that is greater than the stop (first) distance 180. The warning distance 185 may be, for example, 10% greater than the stop distance 180. While the elevator car 103 and counterweight 105 are moving towards each other and move within the warning (second) distance 185, the warning system controller 115A may take a second responsive action (as compared with stopping the car as the first responsive action, indicated above). The second responsive action includes (i) communicating with the car controller 115 for slowing down the elevator car 103 from the second max speed to a third max speed, which is slower than the first and second max speeds; and (ii) sounding a second audible alert that differs from the first audible alert.

In other words, a scenario addressed by the embodiments is the mechanic 220 is on the car 103 while the car is running at the second max speed (the second max allowed in inspection mode). At one distance (e.g., 8 ft), e.g., the stop distance, the car is stopped, e.g., by opening the relay. At a greater distance (within the second distance 185 but outside the stop distance 180), there are options to provide other warning actions, such as sounding an audio and/or visual alarm. The system, in this second distance, can perform a controlled deceleration, via action of the controller.

In one embodiment, while in inspection mode, the warning system controller 115A has the speaker 210 continuously, at a predetermined interval, emits a notification alert (a third audible alert) that generally indicates the system 150 is in the inspection mode. The general notification alert may have a different sound than the alerts within the warning and stop distances, so the mechanic 220 is aware that the system 150 is in the inspection mode while there is a safe distance between the elevator car 103 and the counterweight 105. That is, the notification alerts may include the first sound (first audible alert) when the elevator car 103 and counterweight 105 are separated apart by a distance that within the stop distance 180, the second sound (second audible alert) when the elevator car 103 are between the warning distance 185 and the stop distance 180, and a third sound (the third audible alert) when the distance between the elevator car 103 and the counterweight 105 is greater than the warning distance 185.

In one embodiment, a detectable object 230 is utilized, which may be integrated into the sensor 160, located on a wall 117A of the hoistway 117, or otherwise integrated into the elevator car 103 or the counterweight 105, depending on the location of the sensor 160. The detectable object 230 could be a reflective surface tape or a detectable object. It could be tape with special optical features or an item that has dimensions that would be picked up by a range sensor (1D, 2D or 3D) as an identifiable spatial feature. That is, the sensor 160 and detectable object 230 are respectively located so, e.g., if it is a reflector, that the sensor signal 160A is reflected off it. A change in the reflected brightness may be correlated to the distance between the sensor 160 and the counterweight 105. In the illustrated embodiment, for simplicity, the detectable object 230 is located on a hoistway wall 117A.

For multi-tiered warning responses (a combination of alarms, slowdown or timed deceleration, and opening of the safety chain) there would be multiple objects 230 in the hoistway if the sensor 160 is operating as a binary on/off sensing of the object. If using three tiers of responses, there could be three objects 230A, 230B, and 230C (FIG. 2B) where they are placed at different vertical locations. If the sensor 160 can pick up the relative distance of object 230 from its point of view, then only one object 230 may be needed as its distance is continuously being read and updated as opposed to using a sensor that only detect the presence of the object and not the relative range.

It is to be appreciated that the stop distance 180 is the sensed distance between the elevator car 103 and the counterweight 106 that results in stopping the elevator car 103, at which the relay is opened, and the car is stopped. As indicated, there is a warning distance 185 preceding (outside of) the stop distance (SD) 180 in which warning activities occur, such as slowing down the car and providing an alarm. Generically, the stop distance 180 and warning distance (WD) 185 may be considered alert distances. There may be a series of alert distances (AD), e.g., AD1 (the SD 180), AD2 (the WD 185), etc., where AD1<AD2<AD3, etc., (where “<” means less than or within) and when the distance between the car and counterweight is <ADi (i being a variable) different predetermined responses occur, such as audio sounds of different type, a car slow down if connected to controller, car controlled deceleration, etc.

In one embodiment, the warning distance 185 and stop distance 180 are controllable based on utilization of the elevator car 103, brakes 225 and elevator belt 107. That is, the stop distance 180 can be eight feet or, depending on age and loading of the elevator car 103, the warning system controller 115A can automatically adjust the stop distance 180 to greater than eight feet, such as nine feet. The warning distance 185 may be 10% greater than the stop distance or may increase, e.g., to 20% (as non-limiting examples) depending on age and loading of the elevator car 103. In one embodiment, a mechanic 220 may have the ability reset the safety protocols or override one or more safety features, using a control interface 250 on the top 103A of the elevator car 103. For example, if the mechanic 220 may be able to prevent the elevator car 103 from stopping upon reaching the stop distance 180, or enable the elevator car 103 to restart moving within the stop distance 180, which may be appropriate under certain circumstances.

In one embodiment, after the AHW system recovers from the detection, e.g., once the system activates the e-stop function, then it will revert back to a disabled state after some time or alternatively based on an action by the mechanic (such as pressing an “all clear” switch 300), to enable the car 103 to continue upward movement past the counterweight 105. As such, the controlled stop alerts the mechanic of the counterweight hazard, and upon stopping the car 103, the system would then allow the car 103 to continue move upward.

With the above embodiments, as indicated, the controller acts when the car and counterweight are moving towards each other. That is, in one embodiment, the controller is not going to monitor for whether sensed distance 175 enters an alert distance (AD) if the counterweight and elevator car are not otherwise within an alert distance and the counterweight and elevator are moving away from each other. That is, car direction data is accounted for when determining whether the controller should act. Car direction data may be obtained from the top-of-car inspection box 162 (FIG. 2A) or by monitoring a change in range data between successive scans from which we the direction of motion of the elevator car (or car and counterweight relative to each other) can be inferred.

With the above embodiments the warning system controller 115A does not necessarily need to talk to the main controller 115, but rather can make its own decision autonomously and controls the relay 200. In other embodiments, where different controlled car actions occur at different alert distances (AD), the warning system controller 115A communicates with the car controller 115 to control motion of the elevator car 103.

The sensors disclosed herein may be LiDAR, mm Wave, etc, that have 1D, 2D or 3D field of view. The sensors may be located on the car, the counterweight, or in the hoistway. The sensor targets may be the actual counterweight, the actual car, or an installed detectable item, such as a reflective strip or spatial object, in the hoistway. Sensor outputs could be a continuous signal such as range, or could be a discrete signal if looking for a specific target.

Triggering points include alert distances (AD) including a stopping distance (SD), and one or more additional alert distances. Responses by the warning system controller to the car moving within an alert distance (AD) include opening a relay to stop the car, sending a command to car controller to reduce car speed or sending a command to a car controller to stop with a motion-controlled deceleration rate. The warning system may be setup up with programmable parameters for the AD values, which may be adjustable.

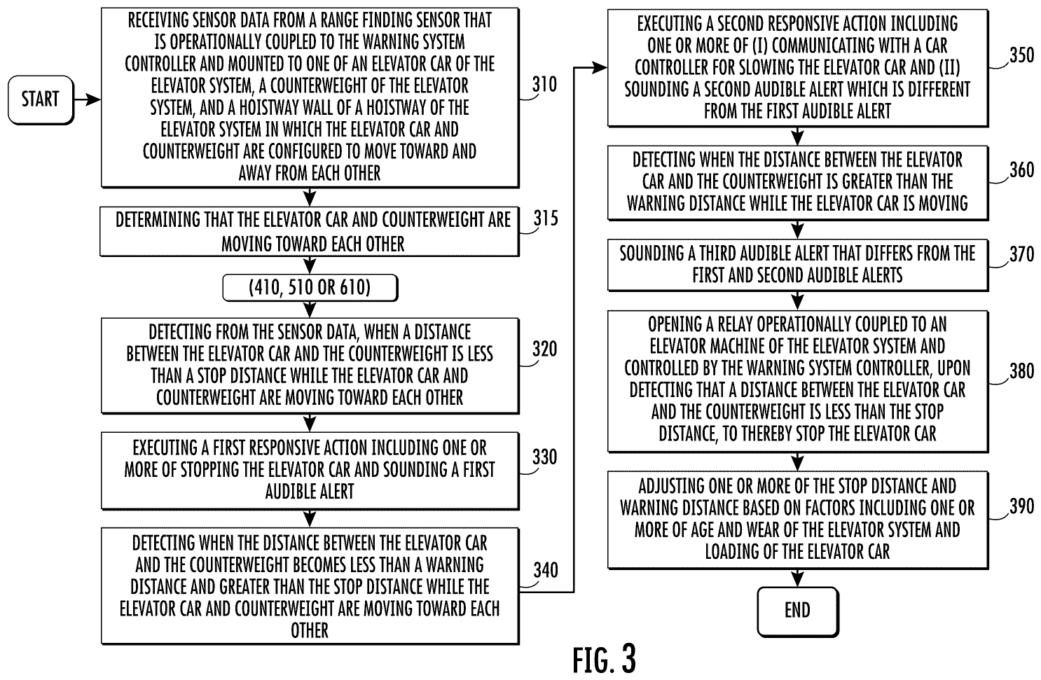

Warning responses by the warning system controller include an audio alarm with pattern of sounds (beeps) or other audio sequence, an audio alarm with a second type of audio signature, etc., a visual alarm and/or an LED light. Turning to FIG. 3, a flowchart shows a method of operating an approaching hazard warning system 150 of the elevator system 101 while the elevator system 101 is in an inspection mode. As shown in block 310 the method includes receiving, by a controller, sensor data from a range finding sensor that is operationally coupled to the controller and mounted to one of an elevator car of the elevator system, a counterweight of the elevator system, and a hoistway wall of a hoistway of the elevator system in which the elevator car and counterweight are configured to move toward and away from each other.

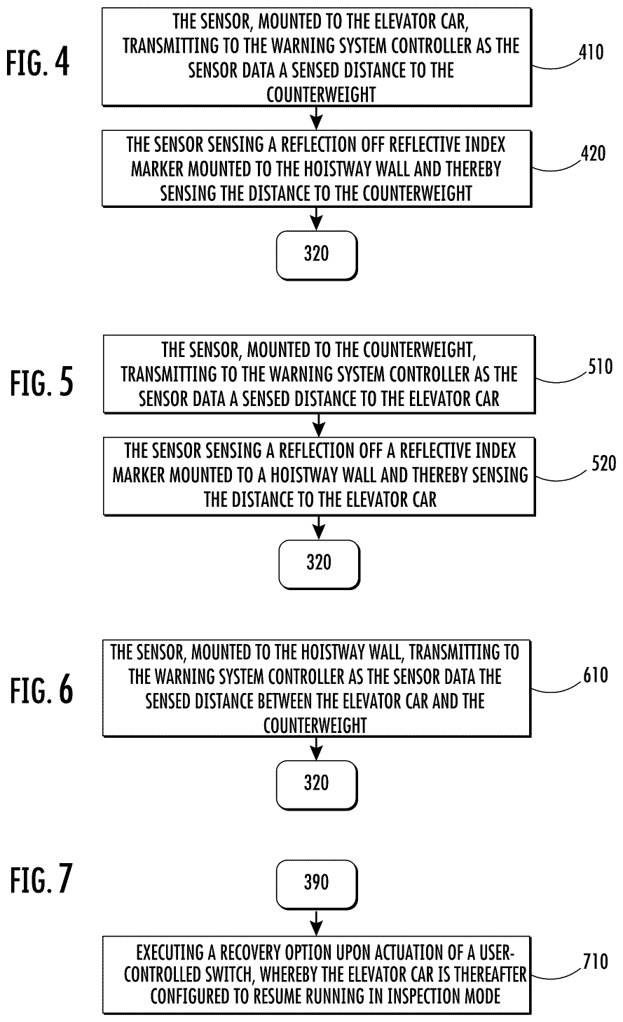

The sensor data 116 is obtained as shown in FIGS. 4-6, discussed in greater detail below.

As shown in block 315, the method includes determining by the warning system controller 115A, that the elevator car 103 and counterweight 1-5 are moving toward each other. That is, as indicated, in one embodiment, the controller 115A is not going to monitor for whether sensed distance 175 enters an alert distance (AD) if the counterweight 105 and elevator car 103 are not otherwise within an alert distance and the counterweight 105 and elevator car 103 are moving away from each other. As indicated, car direction data may be obtained from the top-of-car inspection box 162 (FIG. 2A) or by monitoring a change in range data between successive scans from which we the direction of motion of the elevator car 103 (or car and counterweight relative to each other) can be inferred.

As shown in block 320, the method includes detecting, by the warning system controller 115A, from the sensor data 116, when a distance between the elevator car 103 and the counterweight 105 is less than a stop distance 180 while the elevator car 103 and counterweight 105 are moving toward each other. Under this condition, as shown in block 330, the method includes the warning system controller 115A executing a first responsive action including one or more of stopping the elevator car 103 and sounding a first audible alert.

As shown in block 340, the method includes the warning system controller 115A detecting when the distance between the elevator car 103 and the counterweight 105 becomes less than a warning distance 185 and greater than the stop distance 180 while the elevator car 103 and counterweight 105 are moving toward each other. Under this condition, as shown in block 350 the method includes the warning system controller 115A executing a second responsive action including one or more of (i) communicating with a car controller for slowing the elevator car 103; and (ii) sounding a second audible alert which is different from the first audible alert.

As shown in block 360 the method includes the warning system controller 115A detecting when the distance between the elevator car 103 and the counterweight 105 is greater than the warning distance while the elevator car 103 is moving. Under this condition, as shown in block 370 the method includes sounding a third audible alert that differs from the first and second audible alerts.

As shown in block 380 the method includes opening a relay 200 operationally coupled to an elevator machine 111 of the elevator system 101 and controlled by the warning system controller 115A, upon detecting that a distance between the elevator car 103 and the counterweight 105 is less than the stop distance 180, to thereby stop the elevator car 103.

As shown in block 390 the method includes the warning system controller 115A adjusting one or more of the stop distance 180 and warning distance 185 based on factors including one or more of age and wear of the elevator system 101 and loading of the elevator car 103.

Turning to FIG. 4, in one embodiment, as shown in block 410, the method includes the sensor 160, mounted to the elevator car 103, transmitting to the warning system controller 115A as the sensor data 116 a sensed distance 175 to the counterweight 105. In one embedment, as shown in FIG. 420, the method includes the sensor 160 sensing the detectable object 230 on the hoistway wall 117A and thereby sensing (or inferring) the distance to the counterweight 105. As indicated, for multi-tiered warning responses (a combination of alarms, slowdown or timed deceleration, and opening of the safety chain) there would be multiple objects 230 in the hoistway if the sensor 160 is operating as a binary on/off sensing of the object. If using three tiers of responses, there could be three objects 230A, 230B, and 230C (FIG. 2B) where they are placed at different vertical locations. If the sensor 160 can pick up the relative distance of object 230 from its point of view, then only one object 230 may be needed as its distance is continuously being read and updated as opposed to using a sensor that only detect the presence of the object and not the relative range.

Turning to FIG. 5, in one embodiment, as shown in block 510, the method includes the sensor 160, mounted to the counterweight 105, transmitting to the warning system controller 115A as the sensor data 116 a sensed distance 175 to the elevator car 103. In one embodiment, as shown in block 520, the method includes the sensor 160 sensing the detectable object 230 on the hoistway wall 117A and thereby sensing the distance to the elevator car 103.

Turning to FIG. 6, in one embodiment, as shown in block 610, the method includes the sensor 160, mounted to the hoistway wall 117A, transmitting to the warning system controller 115A as the sensor data 116 the sensed distance 175 between the elevator car 103 and the counterweight 105.

Turning to FIG. 7, in one embodiment the responsive action, e.g., including but not limited to the first responsive action (block 330), includes opening a safety chain and performing an emergency-stop. As shown in block 710, the method includes executing a recovery option upon actuation of a user-controlled switch 300, whereby the elevator car 103 is thereafter configured to resume running in inspection mode.

The above embodiments provide a low-cost safety solution that is relatively easy to install, adjust and verify in operation.

Wireless connections identified above may apply protocols that include local area network (LAN, or WLAN for wireless LAN) protocols and/or a private area network (PAN) protocols. LAN protocols include WiFi technology, based on the Section 802.11 standards from the Institute of Electrical and Electronics Engineers (IEEE). PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. Such wireless connections may also include radio-frequency identification (RFID) technology, used for communicating with an integrated chip (IC), e.g., on an RFID smartcard. In addition, Sub-1 Ghz RF equipment operates in the ISM (industrial, scientific and medical) spectrum bands below Sub 1 Ghz-typically in the 769-935 MHz, 315 Mhz and the 468 Mhz frequency range. This spectrum band below 1 Ghz is particularly useful for RF IOT (internet of things) applications. Other LPWAN-IOT technologies include narrowband internet of things (NB-IOT) and Category M1 internet of things (Cat M1-IOT). Wireless communications for the disclosed systems may include cellular, e.g. 2G/3G/4G (etc.). The above is not intended on limiting the scope of applicable wireless technologies.

Wired connections identified above may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a sever/client protocol designed for use with its programmable logic controllers (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

As indicated, when data is transmitted over a network between end processors, the data may be transmitted in raw form or may be processed in whole or part at any one of the end processors or an intermediate processor, e.g., at a cloud service or other processor. The data may be parsed at any one of the processors, partially or completely processed or complied, and may then be stitched together or maintained as separate packets of information.

Each processor identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random access memory (RAM), read only memory (ROM), or other electronic, optical, magnetic or any other computer readable medium. Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

What is claimed is:

1. An elevator system comprising:
a hoistway having a hoistway wall;
an elevator car that is movable within the hoistway;
a controller operationally coupled to the elevator car;
a counterweight coupled to the elevator car and movable within the hoistway; and
an approaching hazard warning system that includes:
a warning system controller;
a range finding sensor, operationally coupled to the warning system controller, and mounted to one of the elevator car, the counterweight and the hoistway wall,
wherein, while operating in an inspection mode, the warning system controller is configured to receive sensor data from the range finding sensor, determine that the elevator car and counterweight are moving toward each other, detect when a distance between the elevator car and the counterweight is less than a stop distance while the elevator car and the counterweight are moving toward each other, and execute a first responsive action including one or more of slowing the elevator car by communicating with the car controller, stopping the elevator car and sounding a first audible alert.

2. The system of claim 1, wherein, while operating in the inspection mode, the warning system controller is configured to detect when the distance between the elevator car and the counterweight becomes less than a warning distance and greater than the stop distance while the elevator car and the counterweight are moving toward each other, and execute a second responsive action including one or more of (i) communicating with the car controller for slowing the elevator car; (ii) stopping the car; and (iii) sounding a second audible alert which is different from the first audible alert.

3. The system of claim 2, wherein, while operating in the inspection mode, the warning system controller is configured to detect when the distance between the elevator car and the counterweight is greater than the warning distance while the elevator car is moving and sound a third audible alert that differs from the first and second audible alerts.

4. The system of claim 1, including an elevator machine configured to raise and lower the elevator car in the hoistway and a relay operationally coupled to the elevator machine and controlled by the warning system controller, wherein the warning system controller is configured to open the relay upon detecting the distance between the elevator car and the counterweight is less than the stop distance, to thereby stop the elevator car.

5. The system of claim 1, wherein:
the sensor is mounted to the counterweight and configured to transmit to the controller as the sensor data a sensed distance to the elevator car; or
the sensor is mounted to the hoistway wall and configured to transmit to the controller as the sensor data a sensed distance between the elevator car and the counterweight; or
the sensor is mounted to the elevator car and configured to transmit to the warning system controller as the sensor data a sensed distance to the counterweight.

6. The system of claim 5, including a detectable object located on the hoistway wall, wherein the sensor is configured to sense the detectable object and thereby sense the distance to the counterweight.

7. The system of claim 1, wherein:
the sensor is LiDAR or mm Wave; or
the sensor has 1D, 2D or 3D field of view.

8. The system of claim 5, including a detectable object on the hoistway wall, wherein the sensor is configured to sense the detectable object and thereby sense the distance to the elevator car.

9. The system of claim 8, including a plurality of detectable objects mounted on the hoistway, wherein the sensor is configured to sense each of the objects and, responsive to the sensing, the system is configured to execute one or more of a plurality of responsive measures.

10. The system of claim 2, wherein the warning system controller is configured to adjust one or more of the stop distance and the warning distance based on predetermined factors.

11. A method of operating an approaching hazard warning system, of an elevator system, while the elevator system is in an inspection mode, the method comprising:
receiving, by a warning system controller, sensor data from a range finding sensor that is operationally coupled to the warning system controller and mounted to one of an elevator car of the elevator system, a counterweight of the elevator system, and a hoistway wall of a hoistway of the elevator system in which the elevator car and the counterweight are configured to move toward and away from each other;
determining by the warning system controller, that the elevator car and counterweight are moving toward each other,
detecting, by the warning system controller, when a distance between the elevator car and the counterweight is less than a stop distance while the elevator car and the counterweight are moving toward each other; and
executing, by the warning system controller, a first responsive action including one or more of slowing the elevator car by communicating with the car controller, stopping the elevator car and sounding a first audible alert.

12. The method of claim 11, further comprising the warning system controller:
detecting when the distance between the elevator car and the counterweight becomes less than a warning distance and greater than the stop distance while the elevator car and the counterweight are moving toward each other; and
executing a second responsive action including one or more of (i) communicating with a car controller for slowing the elevator car; (ii) stopping the car; and (iii) sounding a second audible alert which is different from the first audible alert.

13. The method of claim 12, further comprising the warning system controller:
detecting when the distance between the elevator car and the counterweight is greater than the warning distance while the elevator car is moving; and
sounding a third audible alert that differs from the first and second audible alerts.

14. The method of claim 11, further comprising the warning system controller:
opening a relay operationally coupled to an elevator machine of the elevator system and controlled by the warning system controller, upon detecting that the distance between the elevator car and the counterweight is less than the stop distance, to thereby stop the elevator car.

15. The method of claim 11, comprising:
the sensor, mounted to the elevator car, transmitting to the warning system controller as the sensor data a sensed distance to the counterweight; or
the sensor sensing the detectable object on the hoistway wall and thereby sensing the distance to the counterweight; or
the sensor, mounted to the counterweight, transmitting to the warning system controller as the sensor data a sensed distance to the elevator car.

16. The method of claim 11, wherein:
the sensor is LiDAR or mmWave; or
the sensor has 1D, 2D or 3D field of view.

17. The method of claim 15, comprising the sensor sensing the detectable object on the hoistway wall and thereby sensing the distance to the elevator car.

18. The method of claim 11, comprising the sensor, mounted to the hoistway wall, transmitting to the warning system controller as the sensor data a sensed distance between the elevator car and the counterweight.

19. The method of claim 12, including the warning system controller adjusting one or more of the stop distance and the warning distance based on predetermined factors.

20. The method of claim 12, wherein:
the first responsive action includes opening a safety chain and performing an emergency-stop; and
the method includes executing a recovery option upon actuation of a user controlled switch, whereby the elevator car is thereafter configured to resume running in inspection mode.
